(19) United States
(12) Patent Application Publication
(10) Pub. No.: US 2026/0288446 A1
(43) Pub. Date: Sep. 24, 2026

(54) SOFTWARE UPDATE DEVICE, SOFTWARE UPDATE METHOD, AND STORAGE MEDIUM

(71) Applicant: HONDA MOTOR CO., LTD., Tokyo (JP)

(72) Inventor: Yutaro Yasuda, Tokyo (JP)

(21) Appl. No.: 19/553,680

(22) Filed: Mar. 2, 2026

(30) Foreign Application Priority Data
Mar. 19, 2025 (JP) 2025-045464

(51) Int. Cl. G06F 8/65

(52) U.S. Cl. CPC G06F 8/65

(57) ABSTRACT

A software update device includes: a software update control unit configured to execute software update processing of updating the software in any of a plurality of update modes, the software update processing being executed by a control device; a mobile object position recognition unit configured to recognize a position of a mobile object; a wireless communication network identification unit configured to identify a wireless communication network to which a communication unit is connected; and an update mode setting unit configured to set the update mode to a first update mode that supports the software update processing in a predetermined area in a case where the position of the mobile object recognized by the mobile object position recognition unit is within the predetermined area and the wireless communication network identified by the wireless communication network identification unit is a specific wireless communication network used in the predetermined area.

### INCORPORATION BY REFERENCE

The present application claims priority under 35 U.S.C. § 119 to Japanese Patent Application No. 2025-045464 filed on Mar. 19, 2025. The content of the application is incorporated herein by reference in its entirety.

### BACKGROUND OF THE INVENTION

### Field of the Invention

The present invention relates to a software update device, a software update method, and a storage medium.

### Description of the Related Art

A technology that performs processing of updating a program written in a non-volatile memory of a control device mounted on a vehicle in any of a normal mode which supports an environment in which a user uses the vehicle and a specific mode which supports an environment different from the environment of the normal mode has been conventionally known. For example, Japanese Patent No. 7264256 discloses a technology that switches the normal mode and the specific mode (a factory mode or a dealer mode) depending on mode information written in the memory of the control device.

In a case where the modes for the processing of updating the software in the control device mounted on the vehicle are switched depending on the information stored in the memory of the control device as with the technology disclosed in Japanese Patent No. 7264256 described above, an operation of writing information for designating the specific mode in the memory when the vehicle is manufactured in the factory is necessary. In addition, an operation of rewriting the mode information for designating the normal mode in the memory when the completed vehicle is shipped is necessary. It is therefore desired to easily switch the modes for the processing of updating the software to reduce the operation load at the time of the manufacture and shipment of the vehicle.

This application has been devised in view of the background described above. An object of this application is to provide a software update device, a software update method, and a storage medium that each make it possible to easily switch modes for processing of updating software in a control device mounted on a mobile object such as a vehicle.

### SUMMARY OF THE INVENTION

A first aspect for achieving the object includes a software update device configured to update software of a control device. The control device is mounted on a mobile object. The software update device includes: a communication unit; a software update control unit; a mobile object position recognition unit; a wireless communication network identification unit; and an update mode setting unit. The communication unit is configured to execute wireless communication. The software update control unit is configured to execute software update processing of updating the software in any of a plurality of update modes based on update data obtained from a software providing device through wireless communication with the software providing device. The wireless communication is executed by the communication unit. The software update processing is executed by the control device. The mobile object position recognition unit is configured to recognize a position of the mobile object. The wireless communication network identification unit is configured to identify a wireless communication network to which the communication unit is connected. The update mode setting unit is configured to set the update mode to a first update mode that supports the software update processing in a predetermined area in a case where the position of the mobile object recognized by the mobile object position recognition unit is within the predetermined area and the wireless communication network identified by the wireless communication network identification unit is a specific wireless communication network used in the predetermined area.

The software update device may have a configuration in which the update mode setting unit sets the update mode to a second update mode that supports the software update processing out of the predetermined area in a case where the position of the mobile object recognized by the mobile object position recognition unit is out of the predetermined area. The software update control unit executes permission confirmation processing of confirming whether or not to permit execution of the software update processing via an input and output device included in the mobile object before executing the software update processing, and the number of steps of the permission confirmation processing in the first update mode is set to be smaller than the number of steps of the permission confirmation processing in the second update mode.

The software update device may have a configuration in which the communication unit is configured as a function of a screen display device mounted on the mobile object and performs wireless communication via Wi-Fi (R).

The software update device may have a configuration in which the software update control unit keeps a screen display device included in the mobile object in a display stop state while the software update processing in the first update mode is being executed.

The software update device may have a configuration in which the software update control unit executes the software update processing when obtaining update start instruction information in the first update mode through wireless communication via the communication unit. The update start instruction information is transmitted from an external device.

The software update device may have a configuration in which the software update control unit quits the software update processing when the software update control unit obtains force-quit instruction information through wireless communication via the communication unit or an operation unit included in the mobile object performs a force-quit instruction operation while the software update processing in the first update mode is being executed. The force-quit instruction information is transmitted from an external device.

In the software update device, the operation unit may be configured as a function of a screen display device mounted on the mobile object.

The software update device may have a configuration in which the communication unit has a Wi-Fi (R) wireless communication function. The software update control unit obtains the force-quit instruction information through wireless communication via Wi-Fi. The wireless communication is executed via the communication unit.

The software update device may have a configuration in which the communication unit has a cellular network wireless communication function. The software update control unit receives the force-quit instruction information through wireless communication via a cellular network. The wireless communication is executed via the communication unit.

A second aspect for achieving the object includes a software update method that is executed by a computer to update software of a control device. The control device is mounted on a mobile object. The software update method includes: a software update control step; a mobile object position recognition step; a wireless communication network identification step; and an update mode setting step. In the software update control step, software update processing of updating the software is executed in any of a plurality of update modes based on update data obtained from a software providing device through wireless communication with the software providing device. The wireless communication is executed by a communication unit configured to execute wireless communication. The software update processing is executed by the control device. In the mobile object position recognition step, a position of the mobile object is recognized. In the wireless communication network identification step, a wireless communication network to which the communication unit is connected is identified. In the update mode setting step, the update mode is set to a first update mode that supports the software update processing in a predetermined area in a case where the position of the mobile object recognized in the mobile object position recognition step is within the predetermined area and the wireless communication network identified in the wireless communication network identification step is a specific wireless communication network used in the predetermined area.

A third aspect for achieving the object includes a non-transitory computer readable storage medium storing a program that causes a computer to function as a software update control unit, a mobile object position recognition unit, a wireless communication network identification unit, and an update mode setting unit to update software of a control device. The control device is mounted on a mobile object. The software update control unit is configured to execute software update processing of updating the software in any of a plurality of update modes based on update data obtained from a software providing device through wireless communication with the software providing device. The wireless communication is executed by a communication unit configured to execute wireless communication. The software update processing is executed by the control device. The mobile object position recognition unit is configured to recognize a position of the mobile object. The wireless communication network identification unit is configured to identify a wireless communication network to which the communication unit is connected. The update mode setting unit is configured to set the update mode to a first update mode that supports the software update processing in a predetermined area in a case where the position of the mobile object recognized by the mobile object position recognition unit is within the predetermined area and the wireless communication network identified by the wireless communication network identification unit is a specific wireless communication network used in the predetermined area.

The software update device, the software update method, and the storage medium each make it possible to easily switch modes for processing of updating software in a control device mounted on a mobile object.

### BRIEF DESCRIPTION OF THE DRAWINGS

FIG. 1 is an explanatory diagram illustrating how software for a vehicle is updated;

FIG. 2 is a configuration diagram of a software update device;

FIG. 3 is a flowchart of update mode setting processing;

FIG. 4 is a flowchart of software update processing in a normal mode; and

FIG. 5 is a flowchart of software update processing in a factory mode.

### DETAILED DESCRIPTION OF THE INVENTION

### 1. How Software is Updated

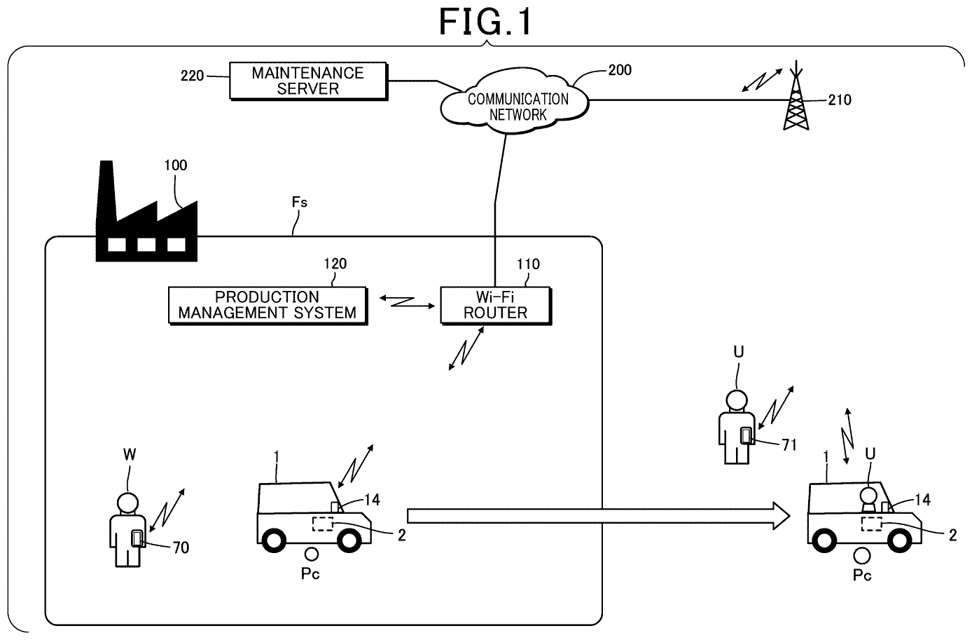

It will be described with reference to FIG. 1 how a software update device 2 according to the present embodiment updates software for a control device mounted on a vehicle 1. FIG. 1 illustrates a situation A1 in which the vehicle 1 is manufactured in a production line of a factory 100 and a situation A2 in which the vehicle 1 shipped from the factory 100 is used by a user U.

The software update device 2 has a wireless communication function. In the factory 100, the software update device 2 communicates with a production management system 120 (computer) used in the factory 100 through a wireless LAN (Local Area Network) in the factory 100 via a Wi-Fi (R) router 110 installed in the factory 100. The Wi-Fi router 110 is connected to a communication network 200 and the software update device 2 communicates with a maintenance server 220 (computer) via the Wi-Fi router 110 and the communication network 200. The maintenance server 220 corresponds to a software providing device according to the present disclosure.

In addition, the software update device 2 performs wireless communication via a cellular network with the maintenance server 220, a worker terminal 70 used by a worker W who takes charge of the manufacture of the vehicle 1 in the factory 100, and a user terminal 71 used by the user U of the shipped vehicle 1 via a base station 210 of the cellular network. The worker terminal 70 and the user terminal 71 are communication terminals such as smartphones, mobile phones, and tablet terminals.

The software update device 2 executes software update processing of updating software of a control device mounted on the vehicle 1 via OTA (Over The Air) using update data downloaded from the maintenance server 220 through wireless communication. The software update device 2 switches a software update mode between a “factory mode” that supports a case where the vehicle 1 is located in the factory 100 and a “normal mode” that supports a situation in which the vehicle 1 is shipped from the factory 100 and the user U starts to use the vehicle 1. The “factory mode” corresponds to a first update mode according to the present disclosure and the “normal mode” corresponds to a second update mode according to the present disclosure.

The software update device 2 executes software update processing in the “normal mode” on the condition of the permission of the user U. Before executing software update processing, the software update device 2 displays a screen that asks for the permission on a display unit 14 included in the vehicle 1 or a display unit of the user terminal 71. Meanwhile, in the “factory mode” in which the user U has not yet started to use the vehicle 1, the software update device 2 executes software update processing without asking for the permission as the condition. This allows the software of the control device mounted on the vehicle 1 to be updated via OTA in the factory 100 and makes it possible to perform an operation of updating the software easier in comparison with a wired connection. In addition, although described in detail below, the software update device 2 sets the software update mode to the “factory mode” depending on the position of the vehicle 1 and the connection status of wireless communication. It is therefore possible to eliminate the necessity for the worker W to perform an operation of switching the update modes.

### 2. Configuration of Software Update Device

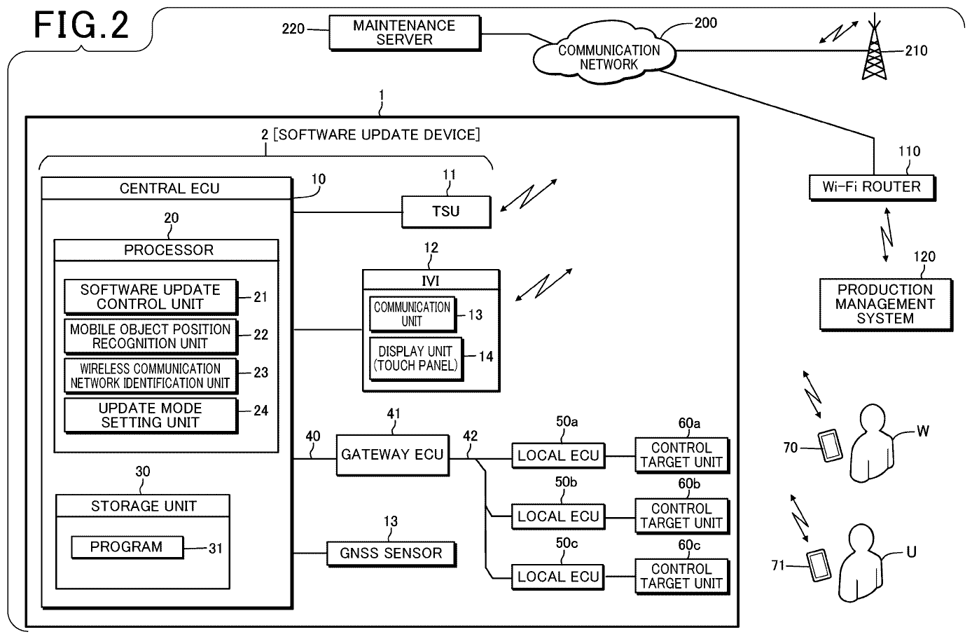

The configuration of the software update device 2 will be described with reference to FIG. 2. The software update device 2 includes some of functions of a central ECU (Electronic Control Unit) 10 mounted on the vehicle 1, a TSU (Telematics Control Unit) 11 (transmitter/receiver, circuit), a communication unit 13 included in IVI (In-Vehicle Infotainment) 12 (computer).

The TSU 11 and the communication unit 13 of the IVI 12 each correspond to a communication unit according to the present disclosure that executes wireless communication. The TSU 11 executes wireless communication via a cellular network and the communication unit 13 of the IVI 12 executes wireless communication via Wi-Fi. The IVI 12 includes the display unit 14 with touch panel specifications. The display unit 14 corresponds to a screen display device according to the present disclosure.

The central ECU 10 is connected to a gateway ECU 41 by a communication line 40. The gateway ECU 41 is connected to a plurality of local ECUs 50a to 50c by a communication line 42. The local ECUs 50 a to 50 c are respectively connected to control target units 60a to 60c and control the actuation of the control target units 60a to 60c. The following generically refers to the local ECUs 50a to 50c as local ECUs 50 and generically refers to the control target units 60a to 60c as control target units 60. The local ECUs 50 each correspond to a control device according to the present disclosure that is mounted on a mobile object. It is to be noted that the two or less or four or more local ECUs 50 may be adopted.

The central ECU 10 executes software update processing of updating software stored in each of the local ECUs 50 via OTA through communication with the maintenance server 220 using update data downloaded from the maintenance server 220. The central ECU 10 includes a processor 20, a storage unit 30. A program 31 for controlling the central ECU 10 is stored in the storage unit 30.

The processor 20 corresponds to a computer according to the present disclosure. The processor 20 reads and executes the program 31 to function as a software update control unit 21, a mobile object position recognition unit 22, a wireless communication network identification unit 23, and an update mode setting unit 24.

The software update control unit 21 executes software update processing in the “normal mode” or the “factory mode” described above. The details of the software update processing in the “normal mode” and the “factory mode” will be described below. The mobile object position recognition unit 22 recognizes the position of the vehicle 1 based on position detection information from a GNSS (Global Navigation Satellite System) sensor 15 included in the vehicle 1. The wireless communication network identification unit 23 identifies a Wi-Fi network to which the communication unit 13 of the IVI 12 is connected. The update mode setting unit 24 sets the update mode for software update processing to the “normal mode” or the “factory mode” based on the position of the vehicle 1 recognized by the mobile object position recognition unit 22 and the Wi-Fi network identified by the wireless communication network identification unit 23.

Processing executed by the software update control unit 21 corresponds to a software update control step of a software update method according to the present disclosure and processing executed by the mobile object position recognition unit 22 corresponds to a mobile object position recognition step of the software update method according to the present disclosure. Processing executed by the wireless communication network identification unit 23 corresponds to a wireless communication network identification step of the software update method according to the present disclosure and processing executed by the update mode setting unit 24 corresponds to an update mode setting step of the software update method according to the present disclosure.

### 3. Update Mode Setting Processing

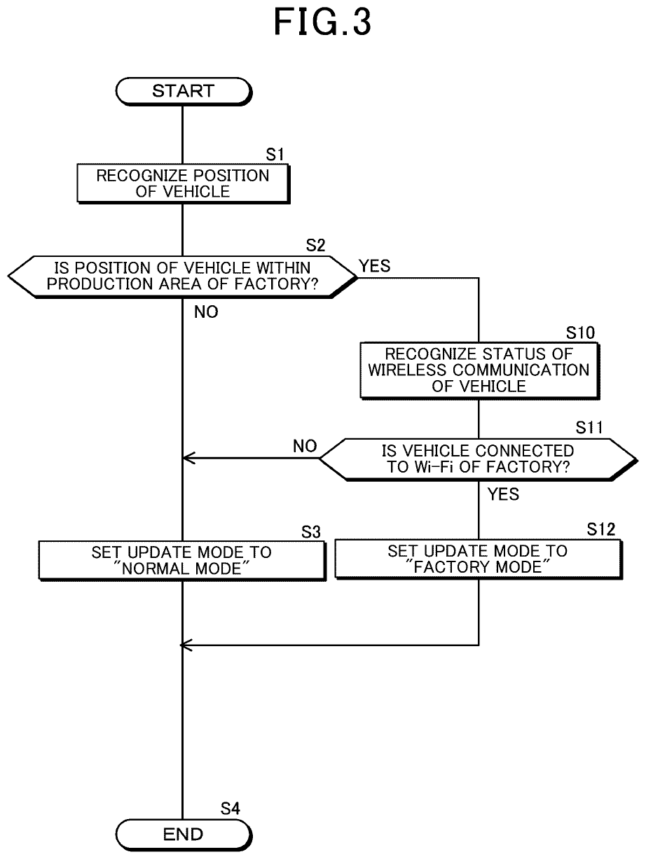

Procedures of update mode setting processing executed by the mobile object position recognition unit 22, the wireless communication network identification unit 23, and the update mode setting unit 24 at the time of the execution of software update processing will be described in accordance with the flowchart illustrated in FIG. 3.

In step S1 of FIG. 3, the mobile object position recognition unit 22 recognizes a position Pc (see FIG. 1) of the vehicle 1 based on the position detection information from the GNSS sensor 15. In subsequent step S2, the update mode setting unit 24 determines whether or not the position Pc of the vehicle 1 recognized by the mobile object position recognition unit 22 is within a production area Fs of the factory 100. The update mode setting unit 24 then advances the processing to step S10 when the position Pc of the vehicle 1 is within the production area Fs. When the position Pc of the vehicle 1 is out of the production area Fs, the update mode setting unit 24 advances the processing to step S3.

In step S3, the update mode setting unit 24 sets the update mode to the “normal mode”. In addition, in step S10, the wireless communication network identification unit 23 identifies a Wi-Fi network to which the communication unit 13 of the IVI 12 is connected. In subsequent step S11, the update mode setting unit 24 determines whether or not the communication unit 13 of the IVI 12 is connected to Wi-Fi (referred to as factory Wi-Fi below) used in the factory 100.

The update mode setting unit 24 then advances the processing to step S12 when the communication unit 13 of the IVI 12 is connected to factory Wi-Fi. When the communication unit 13 of the IVI 12 is not connected to factory Wi-Fi, the update mode setting unit 24 advances the processing to step S3. In step S12, the update mode setting unit 24 sets the update mode to the “factory mode”.

### 4. Software Update Processing in Normal Mode

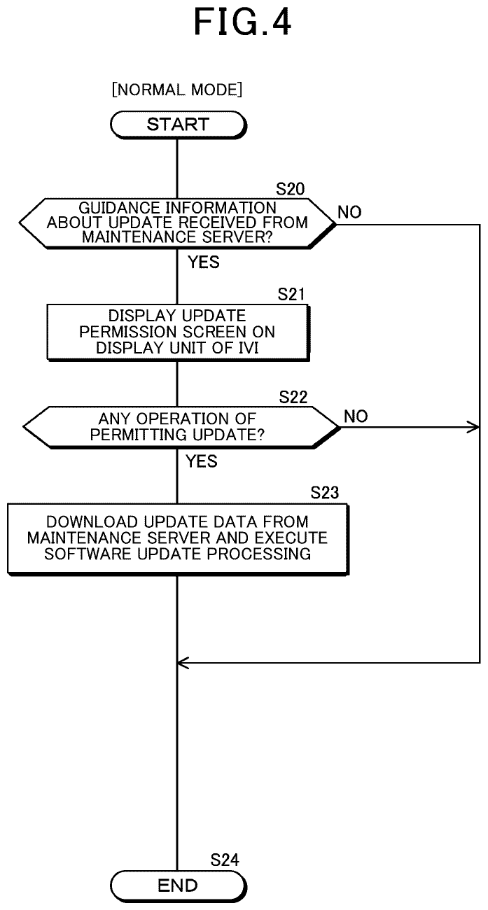

Procedures of software update processing executed by the software update control unit 21 in the “normal mode” will be described with reference to the flowchart illustrated in FIG. 4. The software update control unit 21 repeatedly executes the processing compliant with the flowchart illustrated in FIG. 4 when the vehicle 1 is powered on and the update mode is set to the “normal mode”.

When receiving guidance information about a software update from the maintenance server 220 in step S20 of FIG. 4 through wireless communication by the TSU 11 via a cellular network, the software update control unit 21 advances the processing to step S21. In step S21, the software update control unit 21 displays a permission screen for asking the user U whether or not to permit the update on the display unit 14 of the IVI 12.

In subsequent step S22, the software update control unit 21 determines the presence or absence of an operation of permitting the update by the user U. The software update control unit 21 then advances the processing to step S22 when the permission operation is present. When the permission operation is absent, the software update control unit 21 advances the processing to step S24. In step S23, the software update control unit 21 downloads update data from the maintenance server 220 through wireless communication by the TSU 11 via a cellular network and executes software update processing on each of the local ECUs 50.

### 5. Software Update Processing in Factory Mode

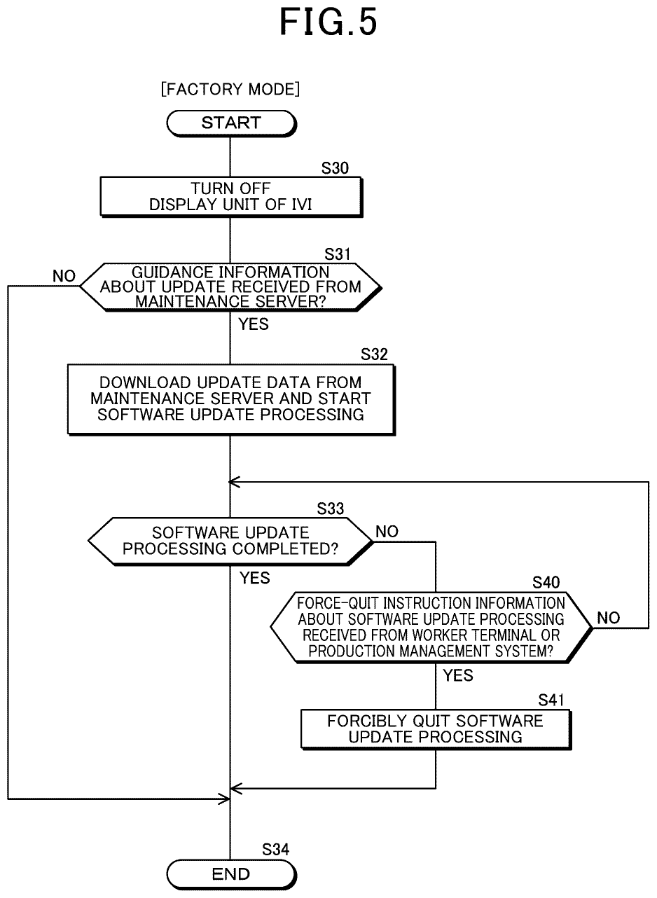

Procedures of software update processing executed by the software update control unit 21 in the “factory mode” will be described with reference to the flowchart illustrated in FIG. 5. The software update control unit 21 repeatedly executes the processing compliant with the flowchart illustrated in FIG. 5 when the vehicle 1 is powered on and the update mode is set to the “factory mode”.

In step S30 of FIG. 5, the software update control unit 21 turns off (disables) the display unit 14 of the IVI 12. When receiving guidance information about an update from the maintenance server 220 in subsequent step S31 through wireless communication by the communication unit 13 of the IVI 12 via factory Wi-Fi, the software update control unit 21 advances the processing to step S32. When receiving no guidance information about an update, the software update control unit 21 advances the processing to step S34.

In step S32, the software update control unit 21 downloads update data from the maintenance server 220 through wireless communication by the communication unit 13 of the IVI 12 via factory Wi-Fi and starts software update processing on each of the local ECUs 50. Through the loop processing of subsequent steps S33 and S40, the software update control unit 21 determines in step S33 whether or not the software update processing is completed and determines in step S40 whether or not force-quit instruction information about the software update processing is received from the worker terminal 70 or the production management system 120.

The software update control unit 21 then advances the processing from step S33 to step S34 when the software update processing is completed. When receiving the force-quit instruction information about the software update processing, the software update control unit 21 advances the processing from step S40 to step S42. In step S41, the software update control unit 21 forcibly quits the software update processing being executed. In this way, accepting the software update processing being forcibly quit makes it possible to forcibly quit the software update processing being executed and switch to processing for an update to the newest version software, for example, when the guidance of the update to the newest version software is received while the software update processing is being executed.

### 6. Other Embodiments

In the embodiment, the vehicle 1 has been exemplified as the mobile object according to the present disclosure. The mobile object according to the present disclosure may be an aircraft, a vessel, or the like.

In the embodiment, the TSU 11 that executes wireless communication via a cellular network and the communication unit 13 of the IVI 12 that executes wireless communication via Wi-Fi network have been each exemplified as the communication unit according to the present disclosure that executes wireless communication. As another embodiment, a communication unit that executes wireless communication compliant with other specifications may be used.

In the embodiment, the production area Fs of the factory 100 has been exemplified as a predetermined area according to the present disclosure. As another embodiment, the predetermined area according to the present disclosure may be a storage space or the like in which a vehicle is temporarily stored before shipment. The storage space is used as the predetermined area to make it possible to update software of a control device mounted on the stored vehicle via OTA.

In the embodiment, the mobile object position recognition unit 22 has recognized the position of the vehicle 1 based on the position detection information from the GNSS sensor 15 included in the vehicle 1. As another embodiment, the mobile object position recognition unit 22 may recognize the position of the vehicle 1 using another technique such as recognizing that the vehicle 1 is located within the production area Fs of the factory 100 by receiving a signal emitted from a beacon installed in the factory 100.

It is to be noted that FIG. 2 is a schematic diagram in which the configuration of the software update device according to the present disclosure is divided in accordance with the chief processing contents for facilitating the understandings of the invention according to this application, but the software update device may be configured in accordance with other division. In addition, the processing of each of the components may be executed by one hardware unit or executed by a plurality of hardware units. In addition, the processing by each of the components illustrated in FIGS. 3 to 5 may be executed by one program or executed by a plurality of programs.

### 7. Configurations Supported by Embodiments Above

The embodiments are specific examples of the following configurations.

(Configuration 1) A software update device configured to update software of a control device, the control device being mounted on a mobile object, the software update device including: a communication unit configured to execute wireless communication; a software update control unit configured to execute software update processing of updating the software in any of a plurality of update modes based on update data obtained from a software providing device through wireless communication with the software providing device, the wireless communication being executed by the communication unit, the software update processing being executed by the control device; a mobile object position recognition unit configured to recognize a position of the mobile object; a wireless communication network identification unit configured to identify a wireless communication network to which the communication unit is connected; and an update mode setting unit configured to set the update mode to a first update mode that supports the software update processing in a predetermined area in a case where the position of the mobile object recognized by the mobile object position recognition unit is within the predetermined area and the wireless communication network identified by the wireless communication network identification unit is a specific wireless communication network used in the predetermined area.

The software update device according to Configuration 1 makes it possible to easily switch the modes for the processing of updating the software by determining that the mobile object is located within the predetermined area and determining whether or not the mobile object is connected to the specific wireless communication network used in the predetermined area.

(Configuration 2) The software update device according to Configuration 1, in which the update mode setting unit sets the update mode to a second update mode that supports the software update processing out of the predetermined area in a case where the position of the mobile object recognized by the mobile object position recognition unit is out of the predetermined area, and the software update control unit executes permission confirmation processing of confirming whether or not to permit execution of the software update processing via an input and output device included in the mobile object before executing the software update processing, and the number of steps of the permission confirmation processing in the first update mode is set to be smaller than the number of steps of the permission confirmation processing in the second update mode.

In a case where the mobile object is located within the predetermined area, the software update device according to Configuration 2 sets a smaller number of steps of the permission confirmation processing of the software update processing than the number of steps set in a case where the mobile object is located out of the predetermined area. This makes it possible to easily set the first update mode that supports the mobile object being located within the predetermined area.

(Configuration 3) The software update device according to Configuration 1 or 2, in which the communication unit is configured as a function of a screen display device mounted on the mobile object and performs wireless communication via Wi-Fi (R).

The software update device according to Configuration 3 makes it possible to execute the software update processing using a Wi-Fi wireless communication function included as the function of the screen display device.

(Configuration 4) The software update device according to any one of Configurations 1 to 3, in which the software update control unit keeps a screen display device included in the mobile object in a display stop state while the software update processing in the first update mode is being executed.

The software update device according to Configuration 4 causes the screen display device to enter the display stop state in a case where the software update processing is executed in a specific situation within the predetermined area. This makes it possible to reduce power to be consumed by the mobile object.

(Configuration 5) The software update device according to any one of Configurations 1 to 4, in which the software update control unit executes the software update processing when obtaining update start instruction information in the first update mode through wireless communication via the communication unit, the update start instruction information being transmitted from an external device.

The software update device according to Configuration 5 makes it possible to control the execution of the software update processing in the first update mode using the external device.

(Configuration 6) The software update device according to any one of Configurations 1 to 5, in which the software update control unit quits the software update processing when the software update control unit obtains force-quit instruction information through wireless communication via the communication unit or an operation unit included in the mobile object performs a force-quit instruction operation while the software update processing in the first update mode is being executed, the force-quit instruction information being transmitted from an external device.

The software update device according to Configuration 6 makes it possible to forcibly quit the software update processing executed in the first update mode by operating the external device or the operation unit of the mobile object.

(Configuration 7) The software update device according to Configuration 6, in which the operation unit is configured as a function of a screen display device mounted on the mobile object.

The software update device according to Configuration 7 makes it possible to configure the operation unit using the function of the screen display device mounted on the mobile object.

(Configuration 8) The software update device according to Configuration 6, in which the communication unit has a Wi-Fi (R) wireless communication function, and the software update control unit obtains the force-quit instruction information through wireless communication via Wi-Fi, the wireless communication being executed via the communication unit.

The software update device according to Configuration 8 makes it possible to obtain the force-quit instruction information from the external device using the Wi-Fi wireless communication function of the communication unit.

(Configuration 9) The software update device according to Configuration 6, in which the communication unit has a cellular network wireless communication function, and the software update control unit receives the force-quit instruction information through wireless communication via a cellular network, the wireless communication being executed via the communication unit.

The software update device according to Configuration 9 makes it possible to obtain the force-quit instruction information from the external device using the cellular network wireless communication function of the communication unit.

(Configuration 10) A software update method that is executed by a computer to update software of a control device, the control device being mounted on a mobile object, the software update method including: a software update control step of executing software update processing of updating the software in any of a plurality of update modes based on update data obtained from a software providing device through wireless communication with the software providing device, the wireless communication being executed by a communication unit configured to execute wireless communication, the software update processing being executed by the control device; a mobile object position recognition step of recognizing a position of the mobile object; a wireless communication network identification step of identifying a wireless communication network to which the communication unit is connected; and an update mode setting step of setting the update mode to a first update mode that supports the software update processing in a predetermined area in a case where the position of the mobile object recognized in the mobile object position recognition step is within the predetermined area and the wireless communication network identified in the wireless communication network identification step is a specific wireless communication network used in the predetermined area.

The execution of the software update method according to Configuration 10 by the computer makes it possible to obtain the workings and effects similar to those of the software update device according to Configuration 1.

(Configuration 11) A non-transitory computer readable storage medium storing a program that causes a computer to function as a software update control unit, a mobile object position recognition unit, a wireless communication network identification unit, and an update mode setting unit to update software of a control device, the control device being mounted on a mobile object, the software update control unit being configured to execute software update processing of updating the software in any of a plurality of update modes based on update data obtained from a software providing device through wireless communication with the software providing device, the wireless communication being executed by a communication unit configured to execute wireless communication, the software update processing being executed by the control device, the mobile object position recognition unit being configured to recognize a position of the mobile object, the wireless communication network identification unit being configured to identify a wireless communication network to which the communication unit is connected, and the update mode setting unit being configured to set the update mode to a first update mode that supports the software update processing in a predetermined area in a case where the position of the mobile object recognized by the mobile object position recognition unit is within the predetermined area and the wireless communication network identified by the wireless communication network identification unit is a specific wireless communication network used in the predetermined area.

The execution of the program of the storage medium according to Configuration 11 by the computer makes it possible to implement the configuration of the software update device according to Configuration 1.

### REFERENCE SIGNS LIST

1 vehicle (mobile object)
2 software update device
10 central ECU
11 TSU
12 IVI
13 communication unit
14 display unit
15 GNSS sensor
20 processor
21 software update control unit
22 mobile object position recognition unit
23 wireless communication network identification unit
24 update mode setting unit
30 storage unit
31 program
41 gateway ECU
50a to 50c local ECU
60a to 60c control target unit
70 worker terminal
71 user terminal
100 factory
110 Wi-Fi router
120 production management system
200 communication network
210 base station
22 maintenance server
W worker
U user

1. A software update device configured to update software of a control device, the control device being mounted on a mobile object, the software update device comprising:
a communication unit configured to execute wireless communication;
a software update control unit configured to execute software update processing of updating the software in any of a plurality of update modes based on update data obtained from a software providing device through wireless communication with the software providing device, the wireless communication being executed by the communication unit, the software update processing being executed by the control device;
a mobile object position recognition unit configured to recognize a position of the mobile object;
a wireless communication network identification unit configured to identify a wireless communication network to which the communication unit is connected; and
an update mode setting unit configured to set the update mode to a first update mode that supports the software update processing in a predetermined area in a case where the position of the mobile object recognized by the mobile object position recognition unit is within the predetermined area and the wireless communication network identified by the wireless communication network identification unit is a specific wireless communication network used in the predetermined area.

2. The software update device according to claim 1, wherein
the update mode setting unit sets the update mode to a second update mode that supports the software update processing out of the predetermined area in a case where the position of the mobile object recognized by the mobile object position recognition unit is out of the predetermined area, and
the software update control unit executes permission confirmation processing of confirming whether or not to permit execution of the software update processing via an input and output device included in the mobile object before executing the software update processing, and a number of steps of the permission confirmation processing in the first update mode is set to be smaller than a number of steps of the permission confirmation processing in the second update mode.

3. The software update device according to claim 1, wherein the communication unit is configured as a function of a screen display device mounted on the mobile object and performs wireless communication via Wi-Fi (R).

4. The software update device according to claim 1, wherein the software update control unit keeps a screen display device included in the mobile object in a display stop state while the software update processing in the first update mode is being executed.

5. The software update device according to claim 1, wherein the software update control unit executes the software update processing when obtaining update start instruction information in the first update mode through wireless communication via the communication unit, the update start instruction information being transmitted from an external device.

6. The software update device according to claim 1, wherein the software update control unit quits the software update processing when the software update control unit obtains force-quit instruction information through wireless communication via the communication unit or an operation unit included in the mobile object performs a force-quit instruction operation while the software update processing in the first update mode is being executed, the force-quit instruction information being transmitted from an external device.

7. The software update device according to claim 6, wherein the operation unit is configured as a function of a screen display device mounted on the mobile object.

8. The software update device according to claim 6, wherein
the communication unit has a Wi-Fi (R) wireless communication function, and
the software update control unit obtains the force-quit instruction information through wireless communication via Wi-Fi, the wireless communication being executed via the communication unit.

9. The software update device according to claim 6, wherein
the communication unit has a cellular network wireless communication function, and
the software update control unit receives the force-quit instruction information through wireless communication via a cellular network, the wireless communication being executed via the communication unit.

10. A software update method that is executed by a computer to update software of a control device, the control device being mounted on a mobile object, the software update method comprising:
a software update control step of executing software update processing of updating the software in any of a plurality of update modes based on update data obtained from a software providing device through wireless communication with the software providing device, the wireless communication being executed by a communication unit configured to execute wireless communication, the software update processing being executed by the control device;
a mobile object position recognition step of recognizing a position of the mobile object;
a wireless communication network identification step of identifying a wireless communication network to which the communication unit is connected; and
an update mode setting step of setting the update mode to a first update mode that supports the software update processing in a predetermined area in a case where the position of the mobile object recognized in the mobile object position recognition step is within the predetermined area and the wireless communication network identified in the wireless communication network identification step is a specific wireless communication network used in the predetermined area.

11. A non-transitory computer readable storage medium storing a program that causes a computer to function as a software update control unit, a mobile object position recognition unit, a wireless communication network identification unit, and an update mode setting unit to update software of a control device, the control device being mounted on a mobile object,
the software update control unit being configured to execute software update processing of updating the software in any of a plurality of update modes based on update data obtained from a software providing device through wireless communication with the software providing device, the wireless communication being executed by a communication unit configured to execute wireless communication, the software update processing being executed by the control device,
the mobile object position recognition unit being configured to recognize a position of the mobile object,
the wireless communication network identification unit being configured to identify a wireless communication network to which the communication unit is connected, and
the update mode setting unit being configured to set the update mode to a first update mode that supports the software update processing in a predetermined area in a case where the position of the mobile object recognized by the mobile object position recognition unit is within the predetermined area and the wireless communication network identified by the wireless communication network identification unit is a specific wireless communication network used in the predetermined area.
